(19) United States
(12) Patent Application Publication
(10) Pub. No.: US 2026/0247038 A1
(43) Pub. Date: Aug. 20, 2026

(54) INFORMATION PROCESSING APPARATUS, METHOD, AND STORAGE MEDIUM

(71) Applicant: CANON KABUSHIKI KAISHA, Tokyo (JP)

(72) Inventor: TSUYOSHI OYA, Kanagawa (JP)

(21) Appl. No.: 19/385,563

(22) Filed: Nov. 11, 2025

(30) Foreign Application Priority Data
Feb. 17, 2025 (JP) 2025-023336

(51) Int. Cl. H04N 23/695; G06T 7/70

(52) U.S. Cl. CPC H04N 23/695; G06T 7/70

(57) ABSTRACT

An information processing apparatus associates image capturing information at a timing at which an image is captured by an image capturing device configured to capture an object, pan-tilt angle information at the timing, and the captured image at the timing, detects an object position from the captured image, calculates a target position angle on basis of a target position at the timing and a reference direction of a pan-tilt device configured to control an image capturing direction of the image capturing device, calculates an object angle on basis of the object position and the reference direction, calculates an object angular velocity that is an angular velocity of the object from two or more of the object angles, calculates an angle difference between the target position angle and the object angle, and calculates a rotation control amount of the pan-tilt device based on the object angular velocity and the angle difference.

### BACKGROUND

### Field of the Technology

The present disclosure relates to an information processing apparatus, a method, and a storage medium.

### Description of the Related Art

A camera is provided with pan, tilt, and zoom adjustment functions. The camera has a mechanism that, in response to an instruction indicating pan and tilt directions with respect to a reference direction of the camera, causes the camera to face those directions. Conventionally, an automatic tracking image-capturing system that tracks an object by analyzing images captured by the camera has been developed. Generally, in an automatic tracking image-capturing system, a direction of an object is sequentially detected from an image captured by the camera, and rotation control of the camera is performed so that the object always becomes positioned at a desired position on the captured image.

As a method of tracking so that an object is correctly captured at a desired position on a captured image, there are methods described in Japanese Patent No. 4699040 and Japanese Patent No. 6557768. In the method described in Japanese Patent No. 4699040, rotation control is performed so that an image region in a movement direction becomes larger than a rear side by calculating a movement direction of an object from a temporal change of position information of an image. In addition, in the method described in Japanese Patent No. 6557768, a delay time is sequentially estimated, and undesirable movement of the camera associated with irregular control delay is avoided by increasing estimation accuracy of a position of an object at a future time at which rotation control is reflected.

However, in conventional methods, for example, in a case in which a subject continues to move at a constant speed, the object may still not be at a desired position on a captured image.

### SUMMARY

An information processing apparatus of one embodiment of the present disclosure associates image capturing information at a timing at which an image is captured by an image capturing device configured to capture an object, pan-tilt angle information at the timing, and the captured image at the timing, detects an object position from the captured image, calculates a target position angle on basis of a target position at the timing and a reference direction of a pan-tilt device configured to control an image capturing direction of the image capturing device, calculates an object angle on basis of the object position and the reference direction, calculates an object angular velocity that is an angular velocity of the object from two or more of the object angles, calculates an angle difference between the target position angle and the object angle, and calculates a rotation control amount of the pan-tilt device based on the object angular velocity and the angle difference.

Features of the present disclosure will become apparent from the following description of embodiments with reference to the attached drawings. The following description of embodiments is described by way of example.

### BRIEF DESCRIPTION OF THE DRAWINGS

FIG. 1 is a block diagram showing a configuration of an automatic tracking control system according to a first embodiment of the present disclosure.

FIG. 2 is a diagram explaining definitions of angles and relationships among the angles in an automatic tracking control system according to the first embodiment of the present disclosure.

FIG. 3 is a diagram showing an example of a state called tracking delay or tracking deviation on an image.

FIG. 4 is a block diagram showing calculation processing in a tracking calculation unit 104.

FIG. 5 is a block diagram showing a configuration of an automatic tracking control system according to a second embodiment of the present disclosure.

### DESCRIPTION OF THE EMBODIMENTS

Hereinafter, embodiments for carrying out the present disclosure will be explained using drawings. It should be noted that a configuration for realizing the present disclosure is not limited to a configuration described in the embodiments. A part of the configuration described in the embodiments may be omitted or replaced with an equivalent within a range in which similar effects are obtained.

### First Embodiment

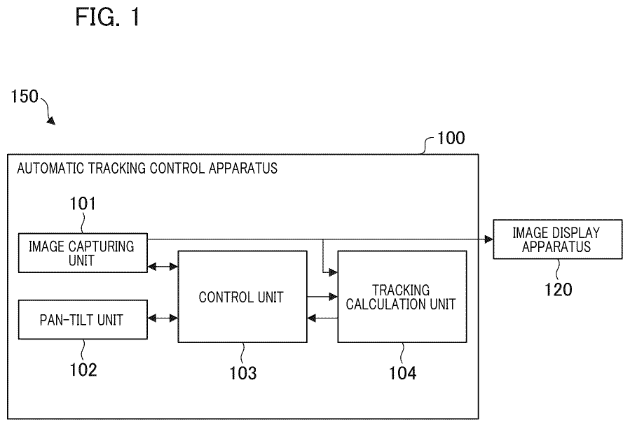

First, a configuration of an automatic tracking control system according to a first embodiment of the present disclosure will be explained. FIG. 1 is a block diagram showing a configuration of an automatic tracking control system according to the first embodiment of the present disclosure. As shown in FIG. 1, an automatic tracking control system 150 according to the first embodiment has an automatic tracking control apparatus 100 and an image display apparatus 120. The automatic tracking control apparatus 100 may be configured to include the image display apparatus 120. The image display apparatus 120 may be disposed at a location away from the automatic tracking control apparatus 100, and an operator may confirm a display of the image display apparatus 120 at a location away from the automatic tracking control apparatus 100. The automatic tracking control apparatus 100 and the image display apparatus 120 may be connected by any known means. The automatic tracking control apparatus 100 is an example of an information processing apparatus that performs control of automatic tracking so that an object is positioned at the target position on a captured image.

The automatic tracking control apparatus 100 has an image capturing unit 101, a pan-tilt unit (a pan-tilt head) 102, a control unit 103, and a tracking calculation unit 104. The image capturing unit 101 is provided with an image sensor, an optical lens, and a lens drive mechanism that drives the image sensor and the optical lens, and the like, performs image capturing continuously or periodically, and outputs a video signal including a captured image to the image display apparatus 120 and the tracking calculation unit 104. The image capturing unit 101 is supported by the pan-tilt unit 102 in a state in which a direction is adjustable. The pan-tilt unit 102 is configured by a motor and the like, and is provided with a pan-tilt drive mechanism capable of changing a direction of the image capturing unit 101. The image capturing unit 101 is an example of an image capturing unit for capturing an object. The pan-tilt unit 102 is an example of a pan-tilt unit that has a predetermined reference direction and supports the image capturing unit so as to be movable in angle with respect to the reference direction.

The control unit 103 adjusts an image capturing range of the image capturing unit 101 by electrically controlling a lens drive mechanism of the image capturing unit 101 and a pan-tilt drive mechanism of the pan-tilt unit 102. Specifically, with respect to a predetermined reference direction of the pan-tilt unit 102, taking a horizontal direction of an image to be captured as pan and a vertical direction as tilt, values of pan and tilt angles from the reference direction are received, and the pan-tilt unit 102 is adjusted so that the image capturing unit 101 is oriented at those angles. In addition, the control unit 103 sequentially receives state information from the pan-tilt drive mechanism, and the control unit 103 outputs pan-tilt-zoom information including angle information of pan and tilt at each reception time to the tracking calculation unit 104. It should be noted that the control unit 103 may control the pan-tilt unit 102 by input of an angle with respect to the reference direction or an angular velocity so that the image capturing unit 101 is oriented in a direction according to the input angle or rotates at the input angular velocity.

The tracking calculation unit 104 takes, as inputs, image data of a captured image from the image capturing unit 101 and pan-tilt-zoom information from the control unit 103, and calculates a rotation control amount for tracking an object by detecting the object from the captured image. The tracking calculation unit 104 realizes tracking and capturing of the object by outputting the calculated rotation control amount to the control unit 103. Details of a calculation method of the rotation control amount will be described below.

In this manner, the tracking calculation unit 104 that receives an image captured by the image capturing unit 101 calculates a rotation control amount, and the control unit 103 controls the pan-tilt unit 102 and the image capturing unit 101 in accordance with the rotation control amount. Accordingly, realizing an image capturing operation that tracks an object is a basic operation of automatic tracking.

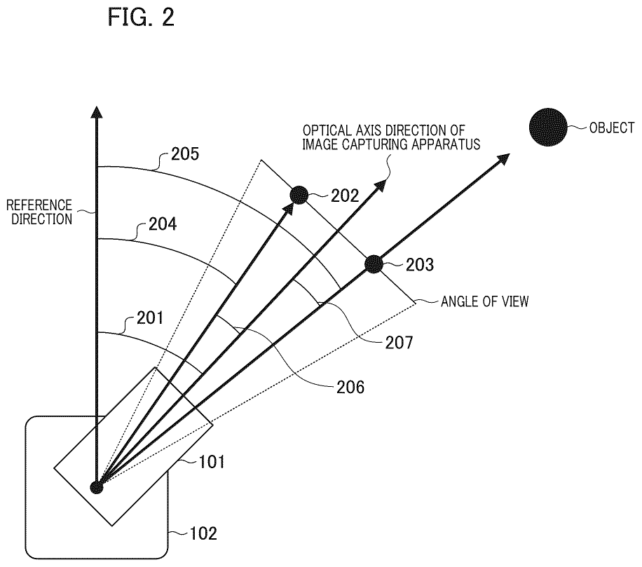

Next, prior to a detailed explanation of the tracking calculation unit 104, definitions of angles in the automatic tracking control system according to the first embodiment of the present disclosure and relationships among the angles will be explained with reference to FIG. 2. FIG. 2 is a diagram explaining a definition of angles in the automatic tracking control system according to the first embodiment of the present disclosure and relationships between those angles, and is a schematic diagram in which the image capturing unit 101 and the pan-tilt unit 102 are viewed from an upper side in a vertical direction of a pan rotation axis.

In FIG. 2, an origin direction of a rotation operation (a rotation operation in a pan direction) of the pan-tilt unit 102 is set as a reference direction. An angle formed by the reference direction and an optical axis direction of the image capturing unit 101 is set as a pan-tilt angle 201, wherein the pan-tilt angle 201 is a pan-tilt angle of the image capturing unit 101. Position coordinates on a captured image at which an object is desired to be arranged are set as a target position 202. A position on a captured image of an object captured by the image capturing unit 101 is set as an object position 203. It should be noted that a captured image captured by the image capturing unit 101 is simply called an image.

In addition, a value obtained by converting the target position 202 into an angle viewed from a focal position in accordance with characteristics of a lens and an image sensor included in the image capturing unit 101 is defined as an image capturing angle 206, wherein the image capturing angle 206 is an image capturing angle of the target position. A value obtained by converting the object position 203 into an angle viewed from the focal position in accordance with characteristics of the lens and the image sensor included in the image capturing unit 101 is defined as an image capturing angle 207, wherein the image capturing angle 207 is an image capturing angle of the object. The image capturing angle 207 is an angle from the optical axis direction of the image capturing unit 101, and the pan-tilt angle 201, wherein the pan-tilt angle 201 is a pan-tilt angle of the image capturing unit 101, is an angle of the pan-tilt unit 102 from the image capturing unit 101.

In this context, an angle of the target position 202 from the pan-tilt unit 102 that is calculated from a relationship between the image capturing angle 206, wherein the image capturing angle 206 is an image capturing angle of the target position, and the pan-tilt angle 201, wherein the pan-tilt angle 201 is a pan-tilt angle of the image capturing unit 101, is defined as a pan-tilt angle 204, wherein the pan-tilt angle 204 is a pan-tilt angle of the target position. Similarly, an angle of the object position 203 from the pan-tilt unit 102 (reference direction) that is calculated from a relationship between the image capturing angle 207, wherein the image capturing angle 207 is an image capturing angle of the object, and the pan-tilt angle 201, wherein the pan-tilt angle 201 is a pan-tilt angle of the image capturing unit 101, is defined as a pan-tilt angle 205, wherein the pan-tilt angle 205 is a pan-tilt angle of the object. In tracking, rotation control is performed with a goal that a difference between the pan-tilt angle 204 of the target position and the pan-tilt angle 205 of the object is eliminated.

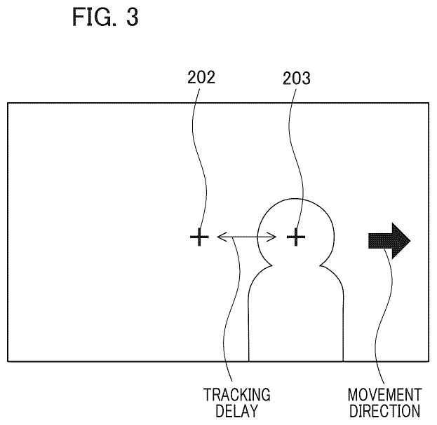

FIG. 3 is a diagram showing an example of a state called tracking delay or tracking deviation on an image. In this example, an object is set as a face of a predetermined person, and the target position 202 is set as the center of the screen. A state in which the object position 203 is positioned on the side of the movement direction of the object relative to the target position 202 is tracking delay. A state in which the object position 203 and the target position 202 are displaced from each other is tracking deviation.

Next, the tracking calculation unit 104 will be explained. The tracking calculation unit 104 receives as inputs image data output by the image capturing unit 101, and image capturing information and pan-tilt angle information output by the control unit 103. The image capturing information from the control unit 103 includes optical information in a lens and an image sensor of the image capturing unit 101. The image capturing information includes, as an example, coordinate values of an optical axis center on an image and a focal length. The pan-tilt angle information is information that indicates the direction in which the image capturing unit 101 is oriented, as instructed to the pan-tilt unit 102, and, as an example, comprises values of a pan angle and a tilt angle. The tracking calculation unit 104 calculates a rotation control amount using the image data, the image capturing information, and the pan-tilt angle information as inputs, and outputs the calculated rotation control amount to the control unit 103.

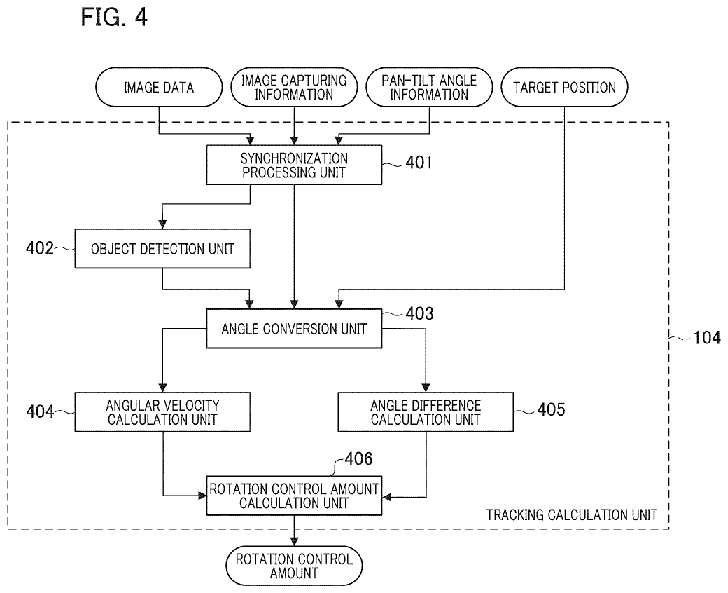

Calculation processing of a rotation control amount performed by the tracking calculation unit 104 will be sequentially explained with reference to the block diagram of FIG. 4. FIG. 4 is a block diagram showing calculation processing in the tracking calculation unit 104. The tracking calculation unit 104 is configured by a synchronization processing unit 401, an object detection unit 402, an angle conversion unit 403, an angular velocity calculation unit 404, an angle difference calculation unit 405, and a rotation control amount calculation unit 406.

The synchronization processing unit 401 performs time synchronization of image data, image capturing information, and pan-tilt angle information that are input to the tracking calculation unit 104. Although image capturing timing of the image data, update timing of the image capturing information, and update timing of the pan-tilt angle information may remain as is in a case in which the timings are identical at an input time, time synchronization processing becomes necessary in a case in which there are differences in update frequency, time delay until acquisition, and the like. As a specific example, in a case in which reception of image data at the tracking calculation unit 104 is delayed relative to reception of image capturing information or pan-tilt angle information, the synchronization processing unit 401 holds a plurality of pieces of image capturing information or pan-tilt angle information. The synchronization processing unit 401 associates image capturing information and pan-tilt angle information with the image data by selecting, from image capturing information and pan-tilt angle information held by the synchronization processing unit 401, the image capturing information and the pan-tilt angle information at a time that matches image capturing timing of the image data.

In addition, in a case in which image capturing timing of image data (captured image) and update timing of pan-tilt angle information do not match, the synchronization processing unit 401 may select pan-tilt angle information in the vicinity of the image capturing timing from a plurality of pieces of the pan-tilt angle information that have been held by the synchronization processing unit 401.

In addition, time information may be included in each of the captured image, the image capturing information, and the pan-tilt angle information. In this case, the synchronization processing unit 401 may generate pan-tilt angle information corresponding to image capturing timing through temporal interpolation calculation from two or more pieces of pan-tilt angle information in the vicinity of the image capturing timing, and associate the generated pan-tilt angle information with the captured image. That is, the synchronization processing unit 401 may generate image capturing information and pan-tilt angle information corresponding to time information of the captured image through interpolation calculation based on time information, and associate the generated image capturing information and the generated pan-tilt angle information with the captured image.

The synchronization processing unit 401 outputs the image data synchronized in this manner to the object detection unit 402, and outputs the image capturing information and the pan-tilt angle information to the angle conversion unit 403.

The object detection unit 402 calculates position information on the image of the object included in the image data, using as input the image data that the synchronization processing unit 401 output and object information that the user set or that is predetermined. For this purpose, for example, an image of the object may be held, and detection by template matching between the image of the object and the image data may be performed, or a method of detecting by AI technology including recent deep learning and the like may be used. AI is an abbreviation for Artificial Intelligence. The calculated position information is the object position 203. The object detection unit 402 outputs the object position 203 to the angle conversion unit 403.

Based on the image capturing information and the pan-tilt angle information that are output from the synchronization processing unit 401, the angle conversion unit 403 converts the target position 202 into a pan-tilt angle 204 that is a pan-tilt angle of the target position, and converts the object position 203 into a pan-tilt angle 205 that is a pan-tilt angle of the object. The pan-tilt angle 204 that is a pan-tilt angle of the target position is an example of a target position angle that is an angle of the target position with respect to a reference direction. The pan-tilt angle 205 that is a pan-tilt angle of the object is an example of an object angle that is an angle of the object with respect to a reference direction. Although the target position 202 is a position on an image at which the object is desired to be arranged and normally is a center of an image, for example, in a case in which the object is a face portion of a person, the target position 202 may be set to an upper portion of an image, and the target position 202 may be configured so as to be settable by the user.

In order to convert position information on an image into angles, image capturing information and pan-tilt angle information are used. In this context, a focal length included in the image capturing information is set to f, and coordinates of the optical axis are set to cₓ and c_{y}. In addition, a pan angle included in the pan-tilt angle information is set to θₛ, and a tilt angle included in the pan-tilt angle information is set to φₛ. In this case, angles in pan and tilt directions from the pan-tilt unit 102 of positions u and v on the image, represented as θ and φ, respectively, can be calculated using Equations (1) to (5). The angle conversion unit 403 outputs a pan-tilt angle 205 that is a pan-tilt angle of the object to the angular velocity calculation unit 404, and outputs a pan-tilt angle 204 that is a pan-tilt angle of the target position and a pan-tilt angle 205 that is a pan-tilt angle of the object to the angle difference calculation unit 405.

$$[ \begin{matrix}{X}_{c} \\ {Y}_{c} \\ {Z}_{c}\end{matrix} ] = {[ \begin{matrix}f & 0 & {c}_{y} \\ 0 & f & {c}_{x} \\ 0 & 0 & 1\end{matrix} ]}^{- 1} [ \begin{matrix}u \\ v \\ 1\end{matrix} ] \qquad ( 1 )$$

$$[ \begin{matrix}{X}_{s} \\ {Y}_{s} \\ {Z}_{s}\end{matrix} ] = [ \begin{matrix}1 & 0 & 0 \\ 0 & cos {φ}_{s} & - sin {φ}_{s} \\ 0 & sin {φ}_{s} & cos {φ}_{s}\end{matrix} ] [ \begin{matrix}cos {θ}_{s} & 0 & sin {θ}_{s} \\ 0 & 1 & 0 \\ - sin {θ}_{s} & 0 & cos {θ}_{s}\end{matrix} ] [ \begin{matrix}{X}_{c} \\ {Y}_{c} \\ {Z}_{c}\end{matrix} ] \qquad ( 2 )$$

$$[ \begin{matrix}x \\ y\end{matrix} ] = [ \begin{matrix}{X}_{s} / {Z}_{s} \\ {Y}_{s} / {Z}_{s}\end{matrix} ] \qquad ( 3 )$$

$$θ = {sin}^{- 1} x \qquad ( 4 )$$

$$φ = {tan}^{- 1} \frac{- y}{\sqrt{1 + {x}^{2}}} \qquad ( 5 )$$

The angular velocity calculation unit 404 calculates an angular velocity corresponding to a movement speed of the object, using as input a pan-tilt angle 205 that was output by the angle conversion unit 403. First, the angular velocity calculation unit 404 holds a received pan-tilt angle 205 for a predetermined period. Then, the angular velocity calculation unit 404 calculates an angular velocity of the object from a plurality of pan-tilt angles 205 that the angular velocity calculation unit 404 is holding. For example, for this processing, dividing a difference between a plurality of pan-tilt angles 205 being held by a time interval between the plurality of pan-tilt angles 205 is simplest. In addition, in a case in which an error is included in a detection result of the object position 203, and the like, an angular velocity may be obtained from a plurality of pan-tilt angles 205 and time intervals between the plurality of pan-tilt angles 205 by a least squares method. The angular velocity calculation unit 404 outputs a calculated angular velocity of the object to the rotation control amount calculation unit 406.

Taking as inputs a pan-tilt angle 204 that was output by the angle conversion unit 403 and a pan-tilt angle 205 that was output by the angle conversion unit 403, the angle difference calculation unit 405 calculates an angle difference by subtracting the pan-tilt angle 205 from the pan-tilt angle 204, and outputs the angle difference to the rotation control amount calculation unit 406.

Taking as inputs an angular velocity of the object that was output by the angular velocity calculation unit 404 and an angle difference that was output by the angle difference calculation unit 405, the rotation control amount calculation unit 406 calculates a rotation control amount that is a control value for rotating the pan-tilt unit 102. As the rotation control amount, an angular velocity for rotating the pan-tilt unit 102 in the pan and tilt directions may be used.

First, an example of a calculation method of a rotation control amount not in accordance with the present disclosure will be explained. This method is a method of calculating an angular velocity v using Equation (6) in a case in which the angle difference is set as Δθ and a time expected until the target position 202 and the object position 203 coincide is set as T.

$$ν = Δθ / τ \qquad ( 6 )$$

In the case of this method, if the object is stationary, the operation becomes such that the target position 202 and the object position 203 coincide after approximately time T. In contrast, in a case in which the object is moving, an optimal state is, ideally, a state in which, when the target position 202 and the object position 203 coincide, an angular velocity accompanying movement of the object and an angular velocity due to rotation of the pan-tilt unit 102 coincide. When the target position 202 and the object position 203 coincide, because Δθ=0, the angular velocity becomes zero, and thereby rotation stops. Actually, convergence occurs to a state in which angular velocities coincide, and, taking an angular velocity accompanying movement of the object as vₜ, a state results in which tracking continues while remaining in a state of an angle difference Δθ that satisfies a relationship of Equation (7).

$$Δθ = {v}_{t} / τ \qquad ( 7 )$$

In order to solve this problem, the present disclosure uses an angular velocity of the object calculated by the angular velocity calculation unit 404. The method according to the present embodiment uses Equation (8) with respect to an angular velocity vₜ of the object.

$$v = \frac{Δθ}{τ} + {v}_{t} \qquad ( 8 )$$

The angular velocity of the object is a value that does not depend on the direction or the rotation speed of the image capturing unit 101, and even when Δθ becomes 0, a state results in which tracking continues while the target position 202 and the object position 203 remain in a coincident state, with v equaling vₜ.

Furthermore, as an application, an explanation will be given of a method of dynamically changing the target position 202 to a rear side in a movement direction according to a movement speed of the object. In a case in which a person moves, for example, there are cases in which it is desirable to take a wide image area in front in a movement direction of the person, and this case is image capturing by so-called front-space composition. As an example, it is assumed that an amount equivalent to a range in which the object moves in time τₖ with respect to an angular velocity vₜ accompanying movement of the object is shifted as the target position 202. This is equivalent to replacing Δθ in Equation (8) with Δθ+vₜ×τₖ. Accordingly, the rotation control amount may be calculated using Equation (9).

$$v = \frac{( Δθ + {v}_{t} {τ}_{k} )}{τ} + {v}_{t} \qquad ( 9 )$$

In this context, where C=(τₖ/τ+1), Equation (9) can be transformed into Equation (10).

$$v = \frac{Δθ}{τ} + {Cv}_{t} \qquad ( 10 )$$

At this time, if C is set to be equal to or greater than 1, front-space composition results, and conversely, if C is set to be less than 1, rear-space composition can be realized. Accordingly, in a case in which the rotation control amount is calculated by using Equation (10) and a value of C in Equation (10) is configured to be adjustable and changeable by the user, specification of dynamic composition with respect to movement of the object can be realized by simple calculation.

That is, the rotation control amount calculation unit 406 calculates a first control speed based on an angle difference output by the angle difference calculation unit 405, and calculates a second control speed based on an object angular velocity that is an angular velocity of the object output by the angular velocity calculation unit 404. In addition, the rotation control amount calculation unit 406 determines an angular velocity as the rotation control amount from the sum of the first control speed and the second control speed. In addition, the second control speed is a value obtained by multiplying the object angular velocity by a constant.

In this manner, the rotation control amount calculated by the rotation control amount calculation unit 406 is output to the control unit 103 as an output of the tracking calculation unit 104. The control unit 103 uses the rotation control amount as input and performs automatic tracking of the object by performing control and adjustment as needed through electrical control so that the pan-tilt unit 102 rotates at a predetermined rotation speed indicated by the rotation control amount. As described above, an explanation has been provided with respect to calculation processing of a rotation control amount performed by the tracking calculation unit 104.

In this manner, according to the present embodiment, a moving subject can be tracked with high accuracy. In addition, according to the present embodiment, because a movement speed of the object that does not depend on a direction of the camera is used, stable tracking that does not depend on variation in control delay time or estimation accuracy can be realized.

### Second Embodiment

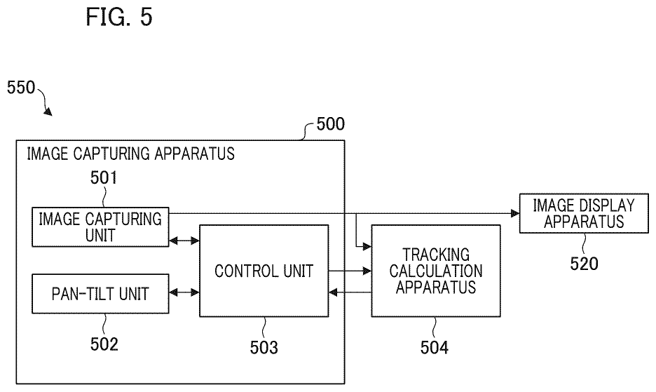

In the First Embodiment, the automatic tracking control apparatus 100 was a configuration such that the image capturing unit 101, the pan-tilt unit 102, the control unit 103, and the tracking calculation unit 104 were integrated. The present disclosure is not limited to this configuration, and the tracking calculation unit 104 may be a separate apparatus. FIG. 5 is a block diagram showing a configuration of an automatic tracking control system according to a second embodiment of the present disclosure. An automatic tracking control system 550 has an image capturing apparatus 500, a tracking calculation apparatus 504, and an image display apparatus 520.

The image capturing apparatus 500 has an image capturing unit 501, a pan-tilt unit 502, and a control unit 503. The image capturing unit 501, the pan-tilt unit 502, and the control unit 503 have functions similar to the image capturing unit 101, the pan-tilt unit 102, and the control unit 103 of FIG. 1. The tracking calculation apparatus 504 has functions similar to the tracking calculation unit 104 in FIG. 1. The image display apparatus 520 has functions similar to the image display apparatus 120 in FIG. 1.

According to the present disclosure, deviation in an image that occurs when tracking a moving subject so as to keep the moving subject at a target position is reduced.

### OTHER EMBODIMENTS

The present disclosure can also be realized by processing in which a program realizing one or more functions of the above-described embodiments is supplied to a system or an apparatus via a network or a storage medium, and one or more processors in a computer of the system or the apparatus read out and execute the program. In addition, the present disclosure can also be realized by a circuit (for example, an ASIC) realizing one or more functions.

As described above, although embodiments of the present disclosure have been explained, the present disclosure is not limited to these embodiments, and various modifications and changes are possible within a scope of the gist thereof.

Embodiment(s) of the present disclosure can also be realized by a computer of a system or apparatus that reads out and executes computer executable instructions (e.g., one or more programs) recorded on a storage medium (which may also be referred to more fully as a “non-transitory computer-readable storage medium”) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)TM), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-023336, filed Feb. 17, 2025, which is hereby incorporated by reference herein in its entirety.

What is claimed is:

1. An information processing apparatus comprising:
one or more memories storing instructions; and
one or more processors executing the stored instructions to:
associate image capturing information at a timing at which an image is captured by an image capturing device configured to capture an object, pan-tilt angle information at the timing, and the captured image at the timing;
detect an object position from the captured image;
calculate a target position angle on basis of a target position at the timing and a reference direction of a pan-tilt device configured to control an image capturing direction of the image capturing device;
calculate an object angle on basis of the object position and the reference direction;
calculate an object angular velocity that is an angular velocity of the object from two or more of the object angles;
calculate an angle difference between the target position angle and the object angle; and
calculate a rotation control amount of the pan-tilt device based on the object angular velocity and the angle difference.

2. The information processing apparatus according to claim 1, wherein the one or more processors further execute the stored instructions to select, in a case in which update timing of the captured image and update timing of the pan-tilt angle information do not match, from a plurality of pieces of the pan-tilt angle information that have been stored, the pan-tilt angle information in a vicinity of an image capturing timing of the captured image, and
wherein the selected pan-tilt angle information, the image capturing information, and the captured image are associated.

3. The information processing apparatus according to claim 1,
wherein the one or more processors further execute the stored instructions to generate, in a case in which the captured image, the image capturing information, and the pan-tilt angle information include time information, the image capturing information and the pan-tilt angle information corresponding to the time information of the captured image by interpolation calculation based on the time information, and
wherein the generated pan-tilt angle information, the generated image capturing information, and the captured image are associated.

4. The information processing apparatus according to claim 1,
wherein, based on a sum of a first control speed calculated based on the angle difference and a second control speed calculated based on the object angular velocity, the rotation control amount is calculated, and
wherein the second control speed is a value obtained by multiplying the object angular velocity by a constant.

5. An information processing method comprising:
associating image capturing information at a timing at which an image is captured by an image capturing device configured to capture an object, pan-tilt angle information at the timing, and the captured image at the timing;
detecting an object position from the captured image;
calculating a target position angle on basis of a target position and a reference direction of a pan-tilt device configured to control an image capturing direction of the image capturing device;
calculating an object angle on basis of the object position and the reference direction;
calculating an object angular velocity that is an angular velocity of the object from two or more of the object angles;
calculating an angle difference between the target position angle and the object angle; and
calculating the rotation control amount based on the object angular velocity and the angle difference.

6. A non-transitory storage medium storing a program for causing a computer to perform an information processing method, the method comprising:
associating image capturing information at a timing at which an image is captured by an image capturing device configured to capture an object, pan-tilt angle information at the timing, and the captured image at the timing;
detecting an object position from the captured image;
calculating a target position angle on basis of a target position at the timing and a reference direction of a pan-tilt device configured to control an image capturing direction of the image capturing device;
calculating an object angle on basis of the object position and the reference direction;
calculating an object angular velocity that is an angular velocity of the object from two or more of the object angles;
calculating an angle difference between the target position angle and the object angle; and
calculating the rotation control amount based on the object angular velocity and the angle difference.
